(19) United States
(12) Patent Application Publication
(10) Pub. No.: US 2024/0032607 A1
(43) Pub. Date: Feb. 1, 2024

(54) AEROSOL PROVISION SYSTEM WITH CHARGE LEVEL INDICATOR

(71) Applicant: NICOVENTURES TRADING LIMITED, London (GB)

(72) Inventor: Tomi VINTOLA, London (GB)

(21) Appl. No.: 18/255,631

(22) PCT Filed: Nov. 30, 2021
(86) PCT No.: PCT/EP2021/083588

§ 371 Date: Jun. 2, 2023

(30) Foreign Application Priority Data
Dec. 2, 2020 (GB) 2019031.0

(51) Int. Cl. A24F 40/95; A24F 40/60; A24F 40/53; H02J 7/00

(52) U.S. Cl. CPC A24F 40/95; A24F 40/60; A24F 40/53; H02J 7/0048

(57) ABSTRACT

An aerosol provision system can include an aerosol provision device including a heater assembly configured to heat aerosol generating material, and a device battery configured to supply power to cause the heater assembly to heat the aerosol generating material; and a base unit configured to removably hold the aerosol provision device, the base unit including a base battery, and the base unit being configured to connect to a power supply to supply electrical charge to the base battery. The system also can include an indicator assembly and a controller.

### PRIORITY CLAIM

The present application is a National Phase entry of PCT Application No. PCT/EP2021/083588, filed Nov. 30, 2021, which claims priority from GB Application No. 2019031.0, filed Dec. 1, 2020, each of which is hereby fully incorporated herein by reference.

### TECHNICAL FIELD

The present disclosure relates to a non-combustible aerosol provision device and a charging apparatus for use therewith.

### BACKGROUND

Attempts have been made to provide alternatives to smoking articles such as cigarettes, cigars and the like that burn tobacco during use to create tobacco smoke. Some examples are devices which generate a tobacco flavored aerosols/vapors and/or flavor infused air. Most of these devices include a base unit battery to supply energy to various components of the devices, such as heating arrangements and control circuitry. The increased functionalities of these devices are becoming more demanding on the base unit battery.

### SUMMARY

According to a first aspect of the present disclosure, there is provided an aerosol provision system comprising an aerosol provision device comprising a heater assembly configured to heat aerosol generating material, and a device battery configured to supply power to cause the heater assembly to heat the aerosol generating material; a base unit configured to removably hold the aerosol provision device, the base unit comprising a base battery, and the base unit being configured to connect to a power supply to supply electrical charge to the base battery; an indicator assembly; and a controller, configured to: determine a level of charge of the device battery; determine a level of charge of the base battery; determine a characteristic of the aerosol provision device; and if the determined characteristic satisfies one or more criterion, cause the indicator assembly to indicate the level of charge of the device battery; and if the determined characteristic fails to satisfy the criterion cause the indicator assembly to indicate the level of charge of the base battery.

In an embodiment of the above embodiment, the aerosol provision system comprises: an aerosol provision device comprising a heater assembly configured to heat aerosol generating material, and a device battery configured to supply power to cause the heater assembly to heat the aerosol generating material; a base unit configured to removably hold the aerosol provision device, the base unit comprising a base battery, and the base unit being configured to connect to a power supply to supply electrical charge to the base battery; an indicator assembly; and a controller, configured to: determine a level of charge of the device battery if the controller is in communication with the device battery; determine a level of charge of the base battery if the controller is in communication with the base battery; determine a characteristic of the aerosol provision device; and if the determined characteristic satisfies one or more criterion, cause the indicator assembly to indicate the level of charge of the device battery; and if the determined characteristic fails to satisfy the criterion cause the indicator assembly to indicate the level of charge of the base battery. In some embodiments the communication between the controller and device battery or base battery is via hard wired connections.

In an embodiment of any of the above embodiments the base battery has, at the time of manufacture, the capacity to fully recharge the device battery a plurality of times. In some embodiments the plurality of times is 2, 3, 4, or 5.

In an embodiment of any of the above embodiments the determined characteristic is whether the aerosol provision device is held by the base unit, and the criterion is satisfied if the aerosol provision device is being held by the base unit.

In an embodiment of any of the above embodiments the determined characteristic is the level of charge of the device battery, and the criterion is satisfied if the level of charge of the device battery is below a threshold value.

In an embodiment of any of the above embodiments the determined characteristic is whether the device battery is being charged, and the criterion is satisfied if the device battery is being charged.

In an embodiment of any of the above embodiments the assembly indicator comprises an array of illuminating elements.

In an embodiment of any of the above embodiments the controller is configured to illuminate one or more elements of the array in a first color to indicate the level of charge of the device battery, and to illuminate one or more elements of the array in a second color to indicate the level of charge of the base battery.

In an embodiment of any of the above embodiments when the base unit is connected to the power supply and the aerosol provision device is held on the base unit, the power supply supplies power directly to the device battery.

In an embodiment of any of the above embodiments when the base unit is connected to the power supply and the aerosol provision device is held on the base unit, the power supply supplies power directly to the device battery and to the base battery. In some embodiments the recharging of the device battery is prioritized over recharging the base battery.

In an embodiment of any of the above embodiments when the base unit is connected to the power supply and the aerosol provision device is held on the base unit, the power supply supplies power to the base battery, and the base battery supplies power to the device battery.

In an embodiment of any of the above embodiments the base unit further comprises the indicator unit and the control unit. In some embodiments of this embodiment the control unit is configured to limit its activities and the information displayed on the indicator unit to those activities and that information relating to the base unit when the aerosol provision device is not held on the base unit.

In an embodiment of the above embodiments the aerosol provision device further comprises one or both of a second indicator unit and a second control unit.

In an embodiment of the above embodiments the second control unit is configured to limit its activities and the information displayed on the second indicator unit to those activities and that information relating to the aerosol provision device when the aerosol provision device is not held on the base unit.

In an embodiment of the above embodiments the second indicator unit is covered when the aerosol provision device is held on the base unit.

In an embodiment of the above embodiments the second control unit is deactivated when the aerosol provision device is held on the base unit.

In an embodiment of any of the above embodiments the aerosol provision device further comprises the indicator unit and the control unit.

In an embodiment of the above embodiment the control unit is configured to limit its activities and the information displayed on the indicator unit to those activities and that information relating to the aerosol provision device when the aerosol provision device is not held on the base unit.

In an embodiment of the above embodiments the base unit further comprises one or both of a second indicator unit and a second control unit.

In an embodiment of the above embodiments the second control unit is configured to limit its activities and the information displayed on the second indicator unit to those activities and that information relating to the base unit when the aerosol provision device is not held on the base unit.

In an embodiment of the above embodiments the second indicator unit is covered when the aerosol provision device is held on the base unit.

In an embodiment of the above embodiments the second control unit is deactivated when the aerosol provision device is held on the base unit.

In an embodiment of any of the above embodiments at least one indicator unit comprises one or more light emitting diodes. In some embodiments at least one of the LEDs are RGB LEDs.

In an embodiment of any of the above embodiments the color of the indicated charge level is dependent on which of the device battery or base battery has the charge level indicated.

In an embodiment of any of the above embodiments the system further comprises a user activated means to cause the indicator assembly to indicate the level of charge of the battery not chosen to be displayed by the control unit.

Further features and advantages of the disclosure will become apparent from the following description of various embodiments of the disclosure, given by way of example only, which is made with reference to the accompanying drawings.

### BRIEF DESCRIPTION OF THE DRAWINGS

FIG. 1 shows a schematic diagram of an embodiment of a non-combustible aerosol provision device according to the present disclosure.

FIG. 2 shows a schematic diagram of an embodiment of a charging apparatus according to the present disclosure connected to the non-combustible aerosol provision device of FIG. 1.

FIG. 3 shows a schematic diagram of an embodiment of a charging apparatus according to the present disclosure connected to the non-combustible aerosol provision device of FIG. 1.

FIG. 4 shows a schematic diagram of the base unit of FIG. 3 in more detail.

FIG. 5 shows a schematic diagram of the base unit of FIG. 3 according to a second example.

FIG. 6 shows a schematic diagram of a non-power source device.

FIG. 7 shows a circuit diagram of a base unit connected to an aerosol generating device.

### DETAILED DESCRIPTION

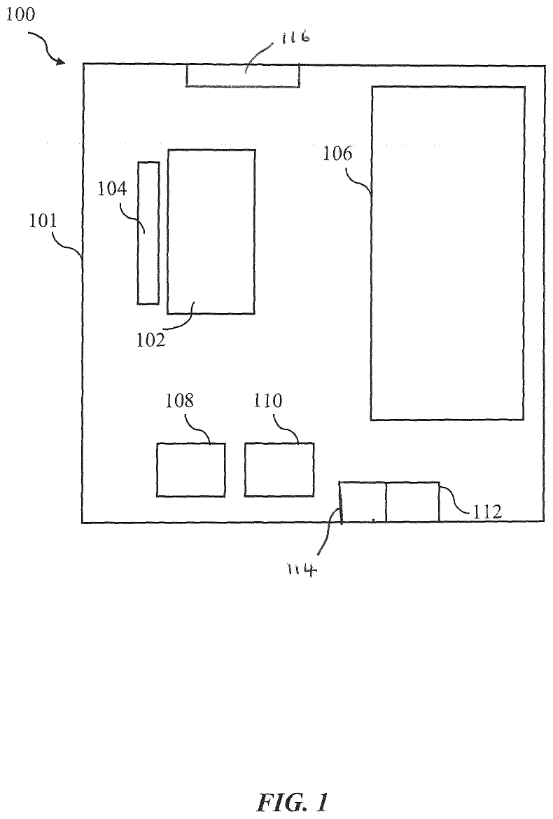

FIG. 1 is a simplified schematic view of a non-combustible aerosol provision device 100. The relative positions and sizes of the various elements of the aerosol provision device 100 in FIGS. 1 to 7 are not indicative of any relative positioning or sizing of an aerosol provision device according to the present disclosure.

According to the present disclosure, a “non-combustible” aerosol provision device is one where an aerosol-generating material is not combusted or burned in order to facilitate delivery of at least one substance to a user. In other words, the non-combustible aerosol provision device provides an aerosol without burning or combusting the aerosol-generating material.

In some examples, the non-combustible aerosol provision device is an electronic cigarette, also known as a vaping device or electronic nicotine delivery system (END), although it is noted that the presence of nicotine in the aerosol-generating material is not a requirement. In such examples, the non-combustible aerosol provision device vaporizes an aerosol-generating material in the form of a liquid.

In some examples, the non-combustible aerosol provision device is an aerosol-generating material heating device, also known as a heat-not-burn device, tobacco heating device, etc., as described above. In such examples, the aerosol generating material may not be in liquid form.

In some examples, the non-combustible aerosol provision device is a hybrid device to generate aerosol using a combination of aerosol-generating materials. In some such examples, one or a plurality of the aerosol-generating materials may be heated. Each of the aerosol-generating materials may be, for example, in the form of a solid, liquid, wax or gel and may or may not contain nicotine. In some examples, the hybrid system comprises a liquid or gel aerosol-generating material and a solid aerosol-generating material. The solid aerosol-generating material may comprise, for example, tobacco or a non-tobacco product.

The non-combustible aerosol provision device 100 comprises a housing 101 that houses the various components of the non-combustible aerosol provision device 100.

The non-combustible aerosol provision device 100 comprises a chamber 102 configured to receive or contain aerosol generating material (not shown). The aerosol generating material may be comprised in a consumable (not shown).

As used herein, the term aerosol-generating material is a material that is capable of generating aerosol, for example when heated, irradiated or energized in any other way. Aerosol-generating material may, for example, be in the form of a solid, liquid or gel which may or may not contain an active substance and/or flavorants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 60 wt % or 70 wt % of amorphous solid, to about 90 wt %, 95 wt % or 100 wt % of amorphous solid. The aerosol-generating material may comprise one or more active substances and/or flavors, one or more aerosol-former materials, and optionally one or more other functional material.

The aerosol-generating material may, for example, include one or more of tobacco, tobacco derivatives, expanded tobacco, reconstituted tobacco or tobacco substitutes. The aerosol-generating material may, for example, be a combination or a blend of materials. The aerosol-generating material may comprise one or more active substances and/or flavors, one or more aerosol-former materials, and optionally one or more other functional material. Aerosol-generating material may also be known as “smokable material”.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some examples, the active substance comprises nicotine. In some examples, the active substance comprises caffeine, melatonin or vitamin B12.

The aerosol-former material may comprise one or more constituents capable of forming an aerosol. In some examples, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, coloring agents, preservatives, binders, fillers, stabilizers, and/or antioxidants.

As used herein, a consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

The non-combustible aerosol provision device 100 comprises an aerosol generator 104 to volatilize at least one component of the aerosolize material. The non-combustible aerosol provision device 100 is hereafter referred to as the device 100.

As used herein, an aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

In examples in which the aerosol generator 104 is a heater, it may be a resistive heater or an inductive heater, for example. Where an inductive heater is used, the inductive heater generates a varying magnetic field in order to heat one or more susceptor elements. The one or more susceptor elements may or may not form part of the aerosol generator 104 in such examples.

A susceptor material is a material that can be heated by penetration with a varying magnetic field, such as an alternating magnetic field. The susceptor material may be an electrically conductive material, so that penetration thereof with a varying magnetic field causes induction heating of the heating material. The susceptor material may be magnetic material, so that penetration thereof with a varying magnetic field causes magnetic hysteresis heating of the susceptor material. The susceptor may be both electrically conductive and magnetic, so that the susceptor can be heated by both heating mechanisms.

The device 100 comprises a power source 106 located within the housing 101. The power source 106 supplies electrical power to the various components of the device 100 including the aerosol generator 104. The power source 106 comprises a rechargeable battery, for example, a lithium ion battery. The rechargeable device battery 106 may comprise a plurality of sub-batteries. In the following examples, the power source 106 is referred to simply as the device battery 106.

In the example of FIG. 1, the device 100 comprises control circuitry 108 which is in data communication with a computer readable storage memory 110. The control circuitry 108 is arranged to control the various aspects and operations of the device 100. For example, the control circuitry 108 may control the delivery of electrical power from the device battery 106 to the aerosol generator 104. In some examples, the control circuitry 108 comprises a micro-processor or the like and associated circuitry for controlling the functions of the device 100.

In the example of FIG. 1, the device 100 comprises an electrical connection port 112 that is in electrical communication with the control circuitry 108 and the device battery 106. Amongst other functions, the electrical connection port 112 facilitates charging of the device battery 106 from a base unit 200. In some non-illustrated examples the device 100 comprises a further electrical connection port adapted to connect to an alternative power source, for example a battery external to the base unit 200 or a mains supply. The further electrical connection port may be an industry standard electrical connection port such as Universal Serial Bus (USB), USB Type C, Micro USB or, in other examples, a proprietary or bespoke connector arrangement. The further electrical connection port may also take the form of a wireless receiver so as to permit wireless charging of the device battery 106.

The control circuitry 108 is further arranged to determine the level of charge of the device battery 106, it achieves this using known methods and components.

The control circuitry 108 is further arranged to determine whether the device 100 is held on the base unit 200. This is via a data connection port 114. The data connection port 114 is adapted to connect to a data connection port 220 of the base unit 200. The control circuitry 108 may detect when the data connection port 114 is connected to the data connection port 220.

The control circuitry 108 is further arranged to send control signals to an indicator display 116. The indicator display 116 comprises one or more light emitting diodes (LEDs) and is capable of illumination in a number of different colors. The indicator display is adapted to provide a display from which a user can understand and/or visualize the charge level of the device battery 106.

It will be appreciated that the device 100 comprises other components not shown in FIG. 1, such as ventilation inlets/outlet, and a control interface to allow user operation of the device 100. It should be noted that FIG. 1 is merely a schematic sketch showing a number of components that could be included in the device 100. FIG. 1 is not intended to communicate particular positions of various components.

FIG. 2 is a simplified schematic diagram of a base unit 200. The base unit 200 comprises a housing 201 which contains and protects the various components of the base unit 200 including a base battery 210. The base battery 210 is a rechargeable battery, for example, a lithium ion battery. The base battery 210 may comprise a plurality of sub-batteries.

As will be explained in more detail below, the base unit 200 is connectable to the device 100 (hold the device 100 on to the base unit 200) in order for the base unit 200 to provide power to charge the device battery 106 of the device 100.

The base unit 200 is also connectable to an external power supply 206, for example, a mains supply. When the base unit 200 is connected to the external power supply 206 the external power supply supplies power to charge the base battery 210 of the charging device 200 when the base battery 210 requires recharging.

The base unit 200 is configured so that when the base unit 200 is connected to the external power supply 206 and to the device 100, the base battery 210 charges the device battery 106 whilst the external power supply 206 charges the base unit 210.

In some embodiments of the present disclosure, the base unit 200 is in the form of a portable carry case that can be used to store and charge the device 100. In effect, this extends the battery life of the device 100 without increasing the size/weight of the device 100 because a user can simply remove the device 100 from the carry case for use.

The base unit 200 comprises a first connection port 202 for connecting to the connection port 112 of the device 100. The connection is a direct port to port connection. In some examples, the first connection port 202 is a bespoke (i.e. proprietary) connection port. For example, the first connection port 202 may comprise two pins (e.g. ground and +5V). The advantage of a bespoke connection port 202 is that it permits only certain compatible devices with a corresponding bespoke connection port to removably connect to the base unit 200. For example, only other proprietary devices made by the manufacturer of the base unit 200. In some other examples, the first connection port 202 may comprise an industry standard electrical connection port, for example, a USB connection port.

The base unit 200 is arranged so that electrical power can be transferred from the base battery 210 of the base unit 200 through the first connection ports 202, 212 to the device battery 106 of the device 100. The electrical power transferred from the base battery 210 thus charges the device battery 106 of the device 100.

As is illustrated in FIG. 2, the base unit 200 comprises a second connection port 204 for connecting to the external power source 206. The connection may be a direct port to port connection, via a suitably arranged connecting cable or a wireless connection. The second connection port 204 is disposed within the housing 201 of the base unit 200 and provides a second electrical connection to the base unit 200. In this example, the second connection port 204 is an industry standard electrical connection port, for example, a USB connection port. This allows many different devices types of power sources to be removably connected to the base unit 200. Of course, other examples of bespoke electrical connection sockets or power transfer arrangements could be used.

In some examples, the external power source 206 connects to a source of mains electricity via a wall socket to supply power via a cable that is connected to the second connection port 204. For example, such a power source could be a charger supplied with the base unit 200 or another generic USB charger connected to the mains supply. In alternative examples, the external power source 206 is a power source from another device, for example, a computer, a car (via a car's power outlet socket), solar panel, or the like connected via a cable or wirelessly to the second connection port 204.

The second connection port 204 is in electrical connection with the base battery 210 through control circuitry 208. Thus, electrical power supplied from the external power source 206 is transferred via the control circuitry 208 to the base unit battery 210 as represented by arrow 216.

The base unit battery 210 of the base unit 200 stores electrical power provided from the external power source 206 and is arranged to provide a number of full charges, for example, at least two, to the device 100. The base unit battery 210 is in electrical connection to the first connection port 202 through the control circuitry 208 as is represented by arrow 212.

As previously mentioned above, the flow of electrical power from the external power source 206 to the base unit battery 210 and the device 100 is controlled by the control circuitry 208. In the example of FIG. 2, the device 100 is connected to the base unit 200, and so electrical power is directed from the base unit battery 210 through the first connection port 202 to the device 100 (shown by arrow 212) when the device battery 106 of the device 100 requires charging.

The base unit 200 further comprises a computer readable storage memory 222. The control circuitry 208 is in data communication with the memory 222.

The base unit 200 further comprises a data connection port 220. The data connection port 220 is adapted to connect to the data connection port 114 of the device 100. The control circuitry 108 and 208 may detect when the data connection port 220 is connected to the data connection port 114. In some embodiments of the present disclosure the data connection ports 220, 114 are such that the control circuitry 108 can transmit data to the control circuitry 208 when the connection ports 220, 114 are engaged with each other.

The control circuitry 208 is further arranged to send control signals to an indicator display 218. The indicator display 218 comprises one or more light emitting diodes (LEDs) and is capable of illumination in a number of different colors. The indicator display is adapted to provide a display from which a user can understand and/or visualize the charge level of the device battery 106 and/or the base battery 210.

The control circuitry 108 and control circuitry 208 are so arranged that when the data connection port 220 is connected to the data connection port 114 the control circuitry 108 deactivates/turns off the indicator assembly 116 on the device 100. In some embodiments, the indicator assembly 116 is so positioned that when the device 100 is held on the base unit 200 the indicator assembly 116 is overlain by a part of the base unit 200 and as such no longer visible to a user of the aerosol provision system of the present disclosure.

The control circuitry 208 is arranged to detect or measure one or more of the following characteristics of the device 100 and or base unit 200: that the device 100 is held by the base unit 200, the level of charge of the device battery 106, and whether the device battery 106 is being charged. The control circuitry 108 then compares the measured characteristic with a criterion set out in one or more tables stored in the memory 222 and sends appropriate control signals to the indicator assembly 218 based on that comparison of the characteristic and the criterion.

In some embodiments of the present disclosure where the control unit 208 is in the base unit 200, the determined characteristic is whether the device 100 is held by the base unit 200 and the criterion is satisfied if the device 100 is being held by the base unit 200, When the criterion is satisfied, the indicator assembly 218 indicates the level of charge of the device battery 106 in a first color, for example blue. When the criterion is not satisfied, the indicator assembly 218 indicates the level of charge of the base battery 210 in a second color, for example green. A user may be educated to know the significance of the color of the indicator assembly 218, or the indicator assembly may further display a guide as to the significance of the color of the indicator assembly 218.

In some embodiments of the present disclosure where the control unit 208 is in the base unit 200, the determined characteristic is the level of charge of the device battery 106 and the criterion is satisfied if the level of charge of the device battery is below a threshold value. When the criterion is satisfied, the indicator assembly 218 indicates the level of charge of the device battery 106 in a first color, for example blue. When the criterion is not satisfied, the indicator assembly 218 indicates the level of charge of the base battery 210 in a second color, for example green.

In some embodiments of the present disclosure where the control unit 208 is in the base unit 200, the determined characteristic is whether the device battery 106 is being charged and the criterion is satisfied if the device battery 106 is being charged. When the criterion is satisfied, the indicator assembly 218 indicates the level of charge of the device battery 106 in a first color, for example blue. When the criterion is not satisfied, the indicator assembly 218 indicates the level of charge of the base battery 210 in a second color, for example green.

In some non-illustrated embodiments of the present disclosure the base unit 200 the assembly indicator 218 comprises an array of illuminating elements and the number of elements in the array that are illuminated is proportional to the level of charge of the device battery 106 or base unit battery 210.

In some non-illustrated embodiments of the present disclosure the base unit 200 is provided with a user operable control means which will cause the control circuitry 208 to send control signals to the indicator assembly to display one or more user selected characteristics of the device 100 and or base unit 200.

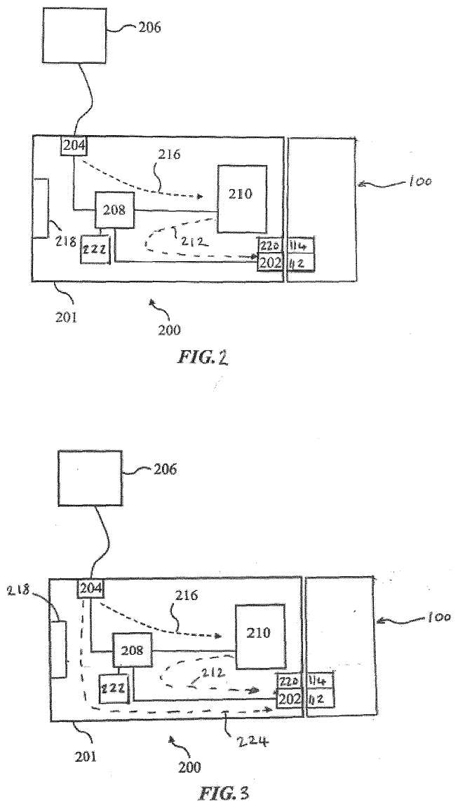

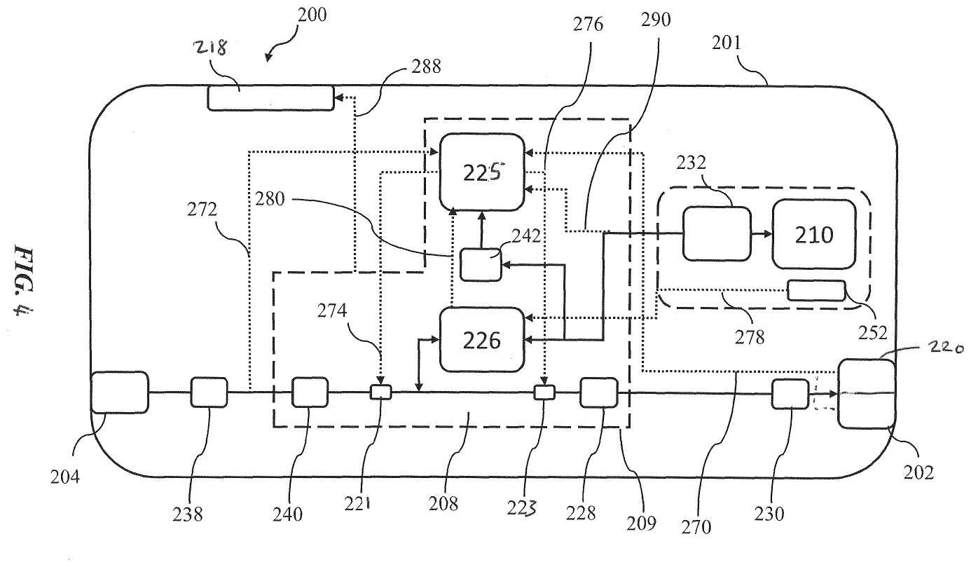

An alternative embodiment of the base unit 200 of the present disclosure is shown schematically in FIG. 3. In FIG. 3 elements of the base unit 200 that are the same as those in the embodiment of the base unit 200 shown in FIG. 2 have the same reference numbers as in FIG. 2 and are as described above.

The difference between the base unit 200 of FIG. 2 and FIG. 3 is that the power source 206 is capable of supplying power directly to first connection port 202 and thus directly charging device battery 106 of the device 100 as indicated by arrow 224.

In the embodiment of FIG. 3, when both the external power source 206 and the device 100 are connected to the base unit 200 and both the device battery 106 of the device 100 and the base unit battery 210 of the base unit 200 require charging, the control circuitry 208 prioritizes directing power from the external power source 206 to charge the device battery 106 of the device 100 over directing power from the external power source 206 to charge the base unit battery 210. In one example, while the device battery 106 of the device 100 is being charged, only if sufficient excess electrical power is available from the external power source 206, will the control circuitry 208 also supply power from the external power source 206 power to charge the base unit battery 210 of the base unit 200.

In another example, when the device battery 106 of the device 100 becomes fully charged, the control circuitry 208 only then starts to supply electrical power from the external power source 206 to charge the base unit battery 210 of the base unit 200.

It will be appreciated that the base unit 200 may comprise other components not shown in FIG. 2 or 3, such as input detectors, charge status indicators, and switches. Moreover, the control unit 208 may comprise other components such as processors, sensors, and voltage regulating circuits. It should be noted that FIG. 2 or 3 are merely schematic drawings showing a number of components that could be included in the base unit 200 or connected thereto. FIGS. 2 and 3 are not intended to communicate particular positions of various components.

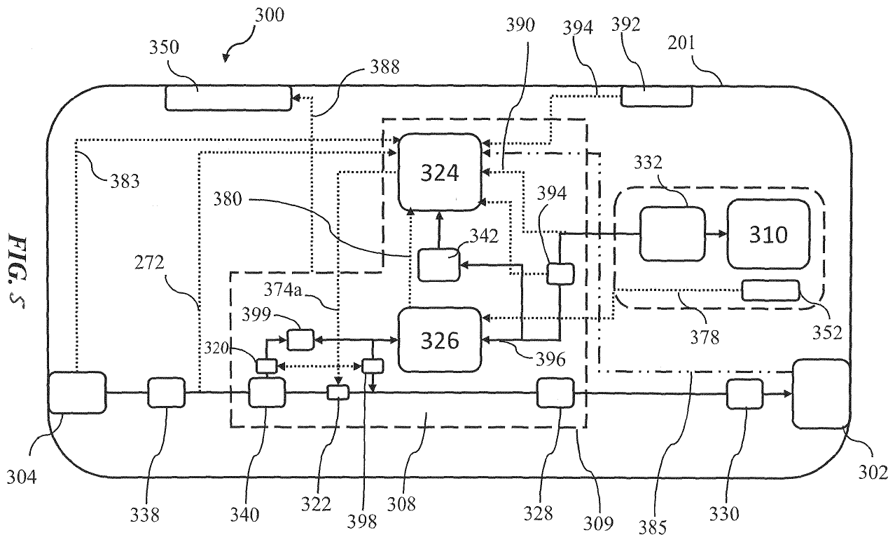

FIG. 4 is a schematic diagram showing the base unit 200 as described in relation to FIG. 3 in more detail. In FIG. 4, the solid arrows represent electrical power lines and dashed arrows represent control and/or monitoring lines between various internal components of the base unit 200. As previously described, the base unit 200 comprises the first connection port 202, the second connection port 204, the control circuitry 208 (indicated in FIG. 4 as a dashed box) and the base unit battery 210.

In this example, the base unit 200 further comprises a first electro-static discharge protection unit 230 and a second electro-static discharge protection unit 238. The first electro-static discharge unit 230 protects the first connection port 202 from electrostatic discharge and is situated between the first connection port 202 and the control circuitry 208. The second electro-static discharge unit 238 protects the second connection port 204 from electrostatic discharge and is situated between the second connection port 204 and the control circuitry 208. The base unit 200 also comprises one or more indicators 218 to indicate the charge level of the base unit battery 210 and/or charge level of the device battery 106.

In some examples, the indicators 218 are a set of light emitting diodes (LED) which are in electrical connection with the control circuitry 208 via a control line 288. The LEDs are used to indicate the charge level of the base unit battery 210 or device battery 106, for example, whether the base unit battery 210 or device battery 106 is fully charged, partially charged, or fully discharged. In one example, the indicator 218 comprises a plurality of RGB LEDs where the different colors indicate different batteries.

In this example, the control circuitry 208 is represented by the dashed box 209 which encompasses various components. The control circuitry 208 comprises a micro controller unit (MCU) 225 (for example a model STM32G031G4). The MCU 225 monitors the first connection port 202 or data port 220 via monitoring line 270 and the second connection port 204 via monitoring line 272 to detect if any devices are connected to the base unit 200 and that the first connection port 202 and second connection port 204 are active. Different external power sources supply different voltage levels and the MCU 225 monitors the voltage level on the monitoring line 272 of a power source or device connected to the second connection port 204. The voltage of the base unit battery 210 is monitored by the MCU 225 over the monitoring line 290.

The control circuitry 208 further comprises an input voltage protection unit 240 to protect the internal components of the base unit 200 from over voltage and/or reverse voltage conditions. In one example, the base unit 200 can handle a +20V supply from USB type C power sources without damaging the internal components and the input protection unit 240 protects the base unit 200 when non-compliant USB type C chargers are connected. The control circuitry 208 further comprises an output voltage protection unit 228 to protect components of the device 100 when connected to the first connection port 203 from over current conditions.

The control circuitry 208 further comprises a low dropout voltage regulator (LDO) 242 to maintain a constant voltage supply from the base unit battery 210 to the MCU 225.

The control circuitry 208 further comprises a charging integrated circuit 226 (charging IC). In this example, the charging IC 226 is a switch mode battery charger, for example, the BQ25303J manufactured by Texas Instruments. The charging IC 226, under the control of the MCU 225, regulates the charging of the base unit battery 210 when a power supply is connected to the second connection port 204 and the base unit battery 210 is being charged. The charging IC 226 is in connection with the MCU 225 via a suitable control line 280, for example, an Inter-Integrated Circuit I²C serial communication bus.

The charging IC 226 monitors the temperature of the base unit battery 210 via a battery temperature monitor line 278 which is connected to a battery temperature sensor 252. The base unit battery 210 is protected from overcharging by a battery protection unit 232. In one example, the battery temperature sensor 252 is in thermal contact with the base unit battery 210 to provide an accurate temperature reading of the base unit battery 210. For example, if while the base unit battery 210 is charging, the temperature begins to reach a temperature that is deemed too hot for the base unit battery 210, the charging IC 226 will reduce the current supply to the base unit battery 210 accordingly. Alternatively, if while the base unit battery 210 is being used to charge the device battery 106 of the device 100 that is connected to the first electrical connection port 202, the base unit battery 210 temperature is deemed too high, the charging IC 226 reduces the current accordingly, or stops the charging to prevent damage to the base unit battery 210. The charging IC 226 may also regulate the supply of electrical power to and from the base unit battery 210 if the temperature of the base unit battery 210 is too cold or below a certain threshold temperature.

The control circuitry 208 further comprises a first switch 221 and a second switch 223. The MCU 225 controls the first switch 221 via a first switch control line 274 and controls the second switch 223 via a second switch control line 276. As will be explained in more detail below, the MCU 225 directs electrical power between the first connection port 202, the second connection port 204 and the base unit battery 210, by controlling the first switch 221 and second switch 223 to either ON or OFF states in various combinations. In one example, the first switch 221 and the second switch 223 are low ohmic Field Effect Transistors (FETs) although other types of switches may also be used.

The operation of the base unit 200, in relation to the configurations shown in FIG. 3 and with reference to the components described in FIG. 4, is further described below.

In one example, only the device 100 is held on the base unit 200 and the device battery 106 of the device 100 is under charged. In this scenario, the MCU 225 detects via the monitoring line 272 that the device 100 is held on the base unit 200 through the first connection port 202 or data port 220 and determines via the monitoring line 270 that no power supply or further device is connected to the base unit 200 through the second connection port 204. The MCU 225 configures the first switch 221 via the switch control line 274 to be in an OFF state and the second switch 223 via the switch control line 276 to be in an ON state. Thus, with the switches in this configuration, electrical power is provided from the base unit battery 210, via the charging IC 226 and the first connection port 202, to charge the device battery 106 of the device 100. No electrical power can flow to the second connection port 204. It will be appreciated that the device 100 will comprise its own charging integrated circuit (not shown) for regulating the charging of the device battery 106 of the device 100 when power is provided in this way from the base unit battery 210 and so, in these circumstances, the charging of the device battery 106 of the device 100, is under the control of the device's 100 own charging integrated circuit (not shown) and not the IC 226. However, in some examples, the IC 226 may convert the voltage of the base unit battery 210 to a value that is compliant with the expected charging voltage of the device 100.

As described above, the charging IC 226 monitors the temperature of the base unit battery 210 and adjusts the output voltage to the first connection port 202 to prevent the base unit battery 210 from overheating and becoming damaged and/or a safety hazard to the user.

In another example, only an external power source 206, is connected to the base unit 200 via the second connection port 204 and the base unit battery 210 is under charged. In this configuration, the MCU 225 detects via the monitoring line 270 that the external power source 206 is connected to the second connection port 204 and determines from the monitoring line 272 that the device 100 is not connected to the base unit 200 through the first connection port 202. The MCU 225 configures the first switch 221 to be in an ON state and the second switch 223 to be in an OFF state via the switch control lines 274 and 276 respectively. When the first switch 221 and second switch 223 are in this configuration and the base unit battery is under charged, electrical power from the external power source 206 is provided via the charging IC 226 to the base unit battery 210 to charge the base unit battery 210. The base unit battery 210 is protected from overcharging by the battery protection unit 232 and the temperature of the battery is monitored during charging by the temperature sensor 252. No electrical power can flow to the first connection port 202.

In another example, as shown in FIG. 4, the device 100 and the external power source 106 are both connected to the base unit 200 via the first connection port 202 and the second connection port 204 respectively. The MCU 225 detects that the device 100 is connected to the first connection port 202 via the monitoring line 272 and that the external power source 206 is connected to the second connection port 204 via the monitoring line 270. Electrical power from the external power source 206 can be provided to the base unit battery 210 or the device battery 106 of the device 100 or both.

The MCU 225 prioritizes charging the device battery 106 of the device 100 over charging the base unit battery 210 of the base unit 200.

In one example, the MCU 225 determines that the device battery 106 of the device 100 is under charged and that the base unit battery 210 is under charged but that the power available from the external power source 106 is sufficient only to meet the charging requirements of the device battery 106 of the device 100. For example, the device battery 106 of the device 100 may require a certain minimum supply voltage, e.g. 5V, for charging and the power source 106 can supply 5V. In this scenario, the MCU 225 configures the first switch 221 and second switch 223 to both be in an ON state via switch control lines 274 and 276 and the charging IC 226 to be OFF. Accordingly, in this scenario, electrical power is provided from the external power source 206 through a path defined by the second connection port 204, the first switch 221, second switch 223 and first connection port 202 to the device 100 and charges the device battery 106 of the device 100 and no electrical power is supplied to the base unit battery 210 As mentioned above, the device 100 will comprise its own charging integrated circuit (not shown) for regulating the charging of the device battery 106 of the device 100 when power is provided in this way from the external power source 206 and so, in these circumstances, the charging of the device battery 106 of the device 100, is under the control of the device's 100 own charging integrated circuit (not shown) and not the IC 226.

The MCU 225 monitors the charge status of the device battery 106 of the device 100 to determine when the device battery 106 of the device 100 reaches a predetermined charge level, for example, fully charged and no longer requires electrical power to be supplied to it. In response to this determination being made, the MCU 225 configures the second switch 223 into an OFF state while maintaining the first switch 221 in the ON state, and switches the charging IC 226 ON to enable power to be provided from the power source 106 via charging IC 226 to charge the base unit battery 210. The voltage of the base unit battery 210 is monitored by the MCU 225 over the monitoring line 290. As is standard with such components, the charging IC 226 controls the current that charges base unit battery 210 based on the input voltage to charging IC 226 (e.g. if the input voltage drops then the charging current is reduced).

The prioritized charging of the device battery 106 of the device 100 over the base unit battery 210 prevents scenarios in which the base unit battery 210 is being charged and the device 100 is not being charged. If a user connects the base unit 200 to an external power source 206 in order to charge its base unit battery 210 and then subsequently connects the device 100 to the base unit 200 to charge the device battery 106 of the device 100, the MCU 225 detects that the device 100 is now connected and that its device battery 106 requires charging. In response to this, as described above, the MCU 225 configures the first switch 221 and the second switch 223 in an ON state and the charging IC 226 in an OFF state to prevent power being provided to the base unit battery 210. In this way, power is directed from the external power source 206 to the device battery 106 of the device 100 rather than to the base unit battery 210 of the base unit 200.

In another example, the MCU 225 determines that the power available from the external power source 206 is sufficient to meet the charging requirements of the device battery 106 of the device 100 and the base unit battery 210 at the same time. For example, the external power source 206 may supply 20V whereas the battery of the device 100 only requires a supply voltage of 5V for charging. In this scenario, the MCU 225 configures the first switch 221 and second switch 223 to both be in an ON state via the switch control lines 274 and 276 respectively and the charging IC 226 to be switched ON. Accordingly, the device battery 106 of the device 100 and the base unit battery 210 are charged by the external power source 206 simultaneously. The MCU 225 and Charging IC 226 monitor the voltage of the base unit battery 210 via monitoring line 290 to prevent overload. The charging IC 226 maintains the base unit battery 210 charging current as high as possible to minimize the charging time.

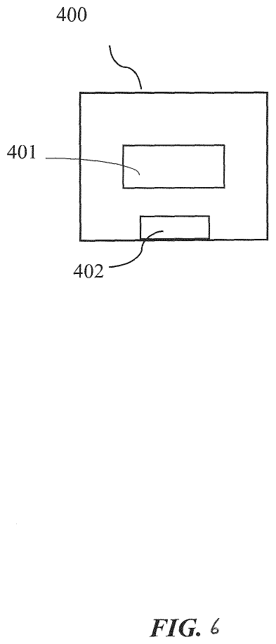

FIG. 5 is a schematic diagram illustrating the internal components of a base unit 300 according to a second example. For brevity, components that are the same as or equivalent to components of the base unit 200 described above with reference to FIG. 4 have the same reference numerals as used in FIG. 4 but increased by 100.

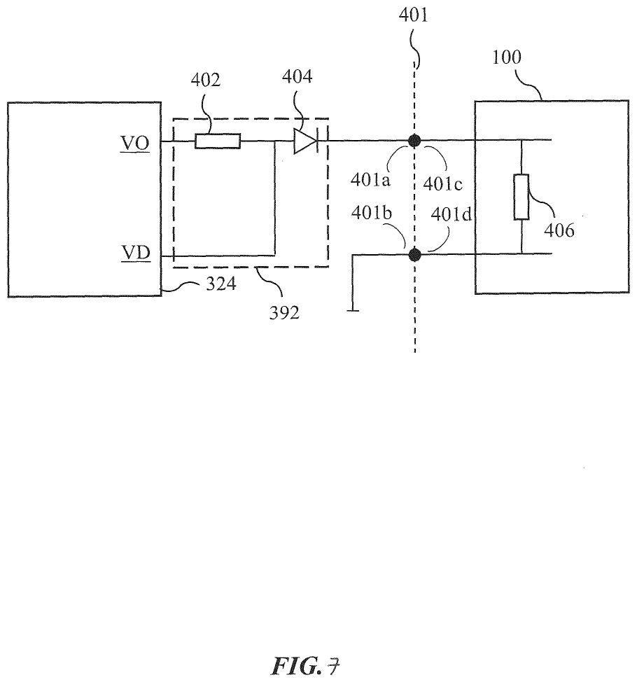

In this example, the base unit 300 comprises a device detection unit 392 which is arranged to detect when a device, such as the device 100, is connected to the first connection port 302. An example of the device detection unit 392 is described below in more detail in relation to FIG. 6.

The MCU 324 is connected to the second connection port 304 via a monitoring line 383 and uses the monitoring line 383 to detect that a device or external power source is connected to the second connection port 304.

The MCU 324 is connected to the first connection port 302 via a data line 385 and uses the data line 385 to receive data from or transmit data to the device 100 when the device 100 is connected to the first connection port 302.

The base unit 300 comprises an input protection unit 399 for protecting the Charging IC 326.

The base unit 300 also comprises a fuel gauge 394 that is in series with an electrical connection 396 between the base unit battery 310 and the charging IC 326. The fuel gauge 394 measures the electrical energy going into or taken out of the base unit battery 310 by measuring the current and voltage of the base unit battery 310.

In this example, the control circuitry 308 comprises a first switch 320, a second switch 322, and a third switch 398 which are controlled by the MCU 324 via a switch control lines 374a (there is control line for each switch although for simplicity only a single line is shown in FIG. 5).

In a first example, the device 100 is connected to the first connection port 302 of the base unit 300, the device battery 106 of the device 100 is under charged and the second connection port 304 is not in use (i.e. not active). In this scenario, the MCU 324 detects via the device detection unit 392 that the device 100 is connected to the base unit 300 and determines via the monitoring line 383 and/or the monitoring line 372 that the second connection port 304 is not in use. The MCU 324 configures the first switch 320 and the second switch 332 to both be in an OFF state and the third switch 398 to be in an ON state. With the switches in this configuration, electrical power stored in the base unit battery 310 is provided vis the charging IC 326 and the first connection port 302 to charge the device battery 106 of the device 100. No electrical power can flow to the second connection port 304.

In a second example, an external power source 206 is connected to the base unit 300 via the second connection port 304 and the base unit battery 310 is under charged and the first connection port 302 is not in use. In this scenario, the MCU 324 detects via the monitoring line 383 and/or monitoring line 372 that the external power source 206 is connected to the second connection port 304 and detects via the device detection unit 392 that the device 100 is not connected to the base unit 300. The MCU 324 configures the first switch 320 to be in an ON state and the second switch 322 and the third switch 398 to both be in an OFF state. With the switches in this configuration, electrical power is provided from the external power source 206 via the charging IC 326 to charge the base unit battery 310.

In a third example, a non-power source device 400, an example of which is schematically illustrated in FIG. 6, is connected to the base unit 300 via the second connection port 304. The non-power source device 400 comprises its own base unit battery 401 and a connection port 402, similar to the connection ports described above, for making the connection to the second connection port 304.

The non-power source devices may, for example, be a camera, mobile telephones, a GPS devices or the like.

In this example, the first connection port 302 is not in use. In this scenario, the MCU 324 detects via the monitoring line 383 and/or monitoring line 372 that a non-power source device 400 is connected to the second connection port 304 and detects via the device detection unit 392 that the device 100 is not connected to the base unit 300. The MCU 324 configures the first switch 320 to be in an ON state and the second switch 322 and the third switch 398 to both be in an OFF state. With the switches in this configuration, electrical power from the base unit battery 310 is provided via the charging IC 326 to charge the base unit battery 401 of the non-power source device 400.

In a fourth example, the device 100 and the non-power source device 400 are both connected to the base unit 300 via the first connection port 302 and the second connection port 304 respectively. The MCU 324 detects that the device 100 is connected to the first connection port 302 via the device detection unit 392 and that the non-power source device 400 is connected to the second connection port 304 via the monitoring line 383 and/or monitoring line 372.

The MCU 324 prioritizes charging the device battery 106 of the device 100 over charging the battery 401 of the non-power source device 400.

In this example, the MCU 324 configures the first switch 320 and the second switch 322 to be in OFF state and the third switch 398 to be in an ON state. Accordingly, electrical power is provided from the base unit battery 310 via a path including the charging IC 326, the third switch 322 and first connection port 302 to charge the device battery 106 of the device 100.

The MCU 324 monitors the charge status of the device battery 106 of the device 100 to determine when the device battery 106 of the device 100 reaches a predetermined charge level, for example fully charged, and no longer requires electrical power to be supplied to it. In response to this determination being made, the MCU 324 configures the first switch 320 into an ON state, the third switch 398 into an OFF state and maintains the second switch 322 in an OFF state. With the switches in this configuration, power is provided from the base unit battery 310 through a path including the charging IC 326, the first switch 320 and the second connection port 302 to charge the battery 401 of the non-power source device 400.

In some examples, simultaneous charging of both the battery 401 of the non power source 400 device and the device battery 106 of the device 100 will occur if there is sufficient electrical power available from the base unit battery 310. That is to say, the device battery 106 of the device 100 is being charged at full capacity and the base unit battery 310 is able to provide additional power to charge the battery 401 of the device 400.

In a fifth example, the device 100 and the external power source 106 are both connected to the base unit 300 via the first connection port 302 and the second connection port 304 respectively. The MCU 324 detects that the device 100 is connected to the first connection port 202 via the device detection unit 392 and that the external power source 106 is connected to the second connection port 304 via the monitoring line 383 and/or monitoring line 370.

The MCU 324 prioritizes charging the device battery 106 of the device 100 over charging the base unit battery 310.

In one scenario, the MCU 324 determines that the device battery 106 of the device 100 is under charged and that the base unit battery 310 is under charged but that the power available from the power source 106 is sufficient only to meet the charging requirements of the device battery 106 of the device 100. For example, the device battery 106 of the device 100 may require a certain minimum supply voltage, e.g. 5V for charging, and the power source 106 can only supply 5V. In this scenario, the MCU 324 configures the first switch 320 and the third switch 398 to be in OFF state and the second switch 322 to be in an ON state. Accordingly, in this scenario, electrical power is provided from the external power source 106 through a path including by the second connection port 304, the second switch 322 and first connection port 302 to charge the device battery 106 of the device 100.

The MCU 324 monitors the charge status of the device battery 106 of the device 100 to determine when the device battery 106 of the device 100 reaches a predetermined charge level, for example fully charged, and no longer requires electrical power to be supplied to it. In response to this determination being made, the MCU 324 configures the first switch 320 into an ON state and the second switch 322 into an OFF state while maintaining the third switch 398 in an OFF state. With the switches in this configuration, power is provided from the power source 106 to charge the base unit battery 310 and no power is provided to the device 100.

In an alternative scenario, the MCU 324 determines that the battery of the device 100 and the base unit battery 310 are under charged and that the power available from the external power source 206 is sufficient to meet the charging requirements of both simultaneously. In this scenario, the MCU 324 configures the first switch 320 and second switch 322 to both be in an ON state and the third switch 398 to be in an OFF state. With the switches in this configuration, power is provided from the power source 106 to charge the base unit battery 210 and the device battery 106 of the device 100 simultaneously.

FIG. 7 is a schematic illustration of the MCU 324 and the device detection unit 392 (represented by the dashed box) of a base unit 300 as described above and the device 100. The dashed line 401 represents a bespoke connection interface between the base unit 300 and the device 100 when the device 100 is connected to the base unit 300. In this example, the first connection port 302 defines the base unit 300 side of the connection interface 401.

The MCU 34 comprises a voltage output pin VO and a voltage detection pin VD. The device detection unit 392 comprises a resistor 402, a diode 404 and first 401a and second 402b contacts. A first end of the resistor 402 is connected to the Voltage output pin VO and a second end of the resistor 402 is connected to the voltage detection pin VD and an anode of the diode 404. A cathode of the diode 404 is connected to the first contact 401a. The second contact 401b is connected to ground.

The device 100 comprises third 401c and fourth 401d electrical contacts and a resistor 406 connected across the third 401c and the fourth 401d electrical contacts.

When the device 100 is connected to the base unit 300, the first electrical contact 401a contacts the third electrical contact 401c and the second electrical contact 401b contacts the fourth electrical contact 401d.

In use, the Voltage output pin VO of the MCU 324 outputs a small fixed voltage and the MCU 324 monitors for a detection voltage level at the detection pin VD.

When the device 100 is connected to the base unit 300, the resistor 402 and the resistor 406 form a potential divider and so the voltage level at the detection pin VD drops to a predetermined detection voltage which is detected by the MCU 324

The reduction in voltage that the MCU 324 detects when the device 100 is connected to the base unit will be determined by the two resistances of the resistors 402 and 406. Accordingly, knowing the two resistances will allow the MCU to identify if the device 100 is connected or a different, un-compatible device. Therefore, it can be envisaged that if an un-compatible device having a different base unit resistance/resistor is connected, the MCU 324 will be able to identify this and prevent the +5V supply 408.

In other examples, the connection interface is not bespoke but instead is defined by standard connector types e.g. Type C USB connectors. In these examples, the MCU 324 may again detect that a device 100 has been connected to the base unit by detecting a high level signal to an output power connector in the interface dropping to a low level signal when the device 100 is connected to the carry case.

The base unit 300 may comprises alternative arrangements to detect when the device 100 is connected, for example, a Hall or a mechanical switch.

In the illustrated examples above, the first electrical connection ports 202 and 302 are bespoke two pin connection ports. Alternatively, the first electrical connection port 202, 302 may be a standard pin connection port, for example, USB type C, or micro-USB or the like. Although in the above examples the first connection ports 202, 302 and second connection ports 204, 304 are described as being pin connectors, it will be appreciated that alternate connection ports may be used to transfer power and/or data into and out of the device. For example, wireless connection ports, wireless charging systems and the like.

The above embodiments are to be understood as illustrative examples of the disclosure. Further embodiments of the disclosure are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An aerosol provision system comprising:
an aerosol provision device comprising:
a heater assembly configured to heat aerosol generating material, and
a device battery configured to supply power to cause the heater assembly to heat the aerosol generating material;
a base unit configured to removably hold the aerosol provision device, the base unit comprising a base battery and being configured to connect to a power supply to supply electrical charge to the base battery;
an indicator assembly; and
a controller configured to:
determine a level of charge of the device battery,
determine a level of charge of the base battery,
determine a characteristic of the aerosol provision device,
and if the determined characteristic satisfies one or more criterion, cause the indicator assembly to indicate the level of charge of the device battery;
and if the determined characteristic fails to satisfy the one or more criterion cause the indicator assembly to indicate the level of charge of the base battery.

2. The aerosol provision system according to claim 1, wherein the determined characteristic is whether the aerosol provision device is held by the base unit, and the one or more criterion is satisfied if the aerosol provision device is being held by the base unit.

3. The aerosol provision system according to claim 1, wherein the determined characteristic is the level of charge of the device battery, and the one or more criterion is satisfied if the level of charge of the device battery is below a threshold value.

4. The aerosol provision system according to claim 1, wherein the determined characteristic is whether the device battery is being charged, and the one or more criterion is satisfied if the device battery is being charged.

5. The aerosol provision system according to claim 1, wherein the indicator assembly comprises an array of illuminating elements.

6. The aerosol provision system according to claim 5, wherein the controller is configured to illuminate one or more illuminating elements of the array of illuminating elements in a first color to indicate the level of charge of the device battery, and to illuminate one or more illuminating elements of the array of illuminating elements in a second color to indicate the level of charge of the base battery.

7. The aerosol provision system according to claim 1, wherein, when the base unit is connected to the power supply and the aerosol provision device is held on the base unit, the power supply supplies power directly to the device battery.

8. The aerosol provision system according to claim 1, wherein, when the base unit is connected to the power supply and the aerosol provision device is held on the base unit, the power supply supplies power to the base battery, and the base battery supplies power to the device battery.

9. The aerosol provision system according to claim 1, wherein the base unit further comprises the indicator assembly and the controller.

10. The aerosol provision system according to claim 9, wherein the controller is configured to limit activities of the controller and information displayed on the indicator assembly to activities and information relating to the base unit when the aerosol provision device is not held on the base unit.

11. The aerosol provision system according to claim 9, wherein the aerosol provision device further comprises at least one of a second indicator assembly or a second controller.

12. The aerosol provision system according to claim 11, wherein the second controller is configured to limit activities of the second controller and information displayed on the second indicator assembly to activities and information relating to the aerosol provision device when the aerosol provision device is not held on the base unit.

13. The aerosol provision system according to claim 11, wherein the second indicator assembly is covered when the aerosol provision device is held on the base unit.

14. The aerosol provision system according to claim 11, wherein the second controller is deactivated when the aerosol provision device is held on the base unit.

15. The aerosol provision system according to claim 1, wherein the aerosol provision device further comprises the indicator assembly and the controller.

16. The aerosol provision system according to claim 15, wherein the controller is configured to limit activities of the controller and information displayed on the indicator assembly to activities and information relating to the aerosol provision device when the aerosol provision device is not held on the base unit.

17. The aerosol provision system according to claim 15, wherein the base unit further comprises at least one of a second indicator assembly or a second controller.

18. The aerosol provision system according to claim 17, wherein the second controller is configured to limit activities and information displayed on the second indicator assembly to activities and information relating to the base unit when the aerosol provision device is not held on the base unit.

19. The aerosol provision system according to claim 17, wherein the second indicator assembly is covered when the aerosol provision device is held on the base unit.

20. The aerosol provision system according to claim 17, wherein the second controller is deactivated when the aerosol provision device is held on the base unit.

21. The aerosol provision system according to claim 1, wherein the indicator assembly comprises one or more light emitting diodes.

22. The aerosol provision system according to claim 1, wherein the color of the indicated level of charge is dependent on which of the device battery or the base battery has the level of charge indicated.

23. The aerosol provision system according to claim 1, wherein the aerosol provision system further comprises a user activated means to cause the indicator assembly to indicate the level of charge of the device battery or the base battery not chosen to be displayed by the controller.
